(19) United States
(12) Patent Application Publication
(10) Pub. No.: US 2006/0137813 A1
(43) Pub. Date: Jun. 29, 2006

(54) Registered lamination of webs using laser cutting

(76) Inventors: Michael J. Robrecht, Shorewood, WI (US); George F. Jambor, Silnger, WI (US)

Correspondence Address: 3M INNOVATIVE PROPERTIES COMPANY, PO BOX 33427, ST. PAUL, MN, 55133-3427, US

(21) Appl. No.: 11/025,559

(22) Filed: Dec. 29, 2004

(51) Int. Cl. B32B 37/00

(52) U.S. Cl. 156/256; 156/350

(57) ABSTRACT

A system and method for manufacturing a multi-layered circuit assembly. The assembly includes a webbing member, a component, and a laminate layer. The method includes providing a roll of the webbing member with the component positioned thereon and a separate roll of the laminate layer, and monitoring a position of the component on the webbing member with an imaging device. The method also includes modifying a portion of the laminate layer at a location that is based on the monitored position of the component on the webbing member, and coupling the laminate layer to the webbing member to provide a continuous sheet of multi-layered circuit. The multi-layered circuit is formed with the component positioned between the webbing member and the laminate layer and aligned with the modification in the laminate layer.

### FIELD OF INVENTION

The present invention generally relates to manufacturing processes and methods wherein layers are added to a flexible webbing, and more particularly relates to registration of webs and layers and cutting of the same.

### BACKGROUND

The popularity of touch screens has increased significantly over the past several years. Many different technologies have been explored in an effort to produce a high-quality touch sensor that is reliable and cost effective. Examples of touch sensor technologies include capacitive, resistive, near field imaging (NFI), acoustical wave, infrared, and force. Common applications for touch sensors include computer monitors and mobile and handheld devices, such as personal digital assistants (PDAs) and tablet computers.

Touch sensors typically possess features and qualities that are unique for a given technology. Each type of touch sensor technology presents specific challenges related to, for example, the recognition of a touch input, the determination of the position of a touch input to a touch sensitive structure of the sensor, reliability, size, weight, and cost.

Most touch sensors are embedded in an electrical membrane panel to be used in a monitor or handheld device. Electrical membrane panels of the type to which the present invention relates include spaced first and second conductive circuits that are formed on separate layers of flexible polymer-based film, webbing, or insulating laminate layers. One common method for producing this type of panel is to form the circuits on individual sheets of plastic film and then join the two sheets of film together after the two circuits have been completely formed. The sheets may be joined together using, for example, a lamination process. This technique can be expensive and entail difficult and time-consuming hand lay-up and registration operations, particularly when the plastic films are very thin, for example, in the range of about 1 mil to 5 mils thick. The separate films are typically hand registered in stacks and then laminated with rollers or in a press or autoclave under heat and pressure.

Another technique includes laminating rolls of web with other layers of web or laminate. The roll of completed product may be cut to any desired length. This technique has certain drawbacks as well. A circuit positioned in the continuous roll of laminated webbing can be difficult to access for the purpose of coupling to a circuit board or to a hard wire connection. Circuit parts can be positioned such that the tail area of a part is exposed along a side of the web for connection as described in U.S. Pat. No. 5,062,016. When this technique is used for a grid type circuit in which conductive traces are aligned in orthogonal X and Y directions, leads to the conductive traces must extend to the sides of the web in order to be exposed for later connection. This restriction on the routing and access points of the conductive traces can result in limitations related to manufacturing efficiency, cost-effective production of parts, and design options for the circuit components and electronic devices that use those components.

### SUMMARY OF THE INVENTION

The invention generally relates to systems and methods that are used to generate multi-layered circuit assemblies. The multi-layered circuit assemblies are of the type commonly formed as a continuous roll of various layers of webbing, laminate, and components or patterns positioned between the webbing and laminate layers. The multi-layered circuit may include a single layer of components or multiple layers of components with intervening layers of webbing or laminate material. The invention provides, in some respects, techniques that allow for more efficient utilization of web area on the webbing. For example, components can be positioned such that the tail area of a part can be located in the middle of the webbing rather than along the edge of the webbing and still be exposed for future connection.

The invention effectively eliminates the need for manual handling of the webbing or laminate layers just before and during engagement of the layers, for which handling is required in many known processes to ensure proper alignment of the components relative to the layers. The invention also eliminates the need for equipment such as an autoclave, press, or stretching machinery due to the automated registry of the layers and nipping of the layers together.

One aspect of the invention relates to a method of manufacturing a multi-layered circuit assembly. The assembly includes a webbing member, a component, and a laminate layer. The method includes providing a roll of the webbing member with the component positioned thereon, providing a separate roll of the laminate layer, and monitoring a position of the component on the webbing member with a position detection device. The method also includes modifying a portion of the laminate layer at a location that is based on the monitored position of the component on the webbing member, and coupling the laminate layer to the webbing member to provide a continuous sheet of multi-layered circuit. The multi-layered circuit is formed with the component positioned between the webbing member and the laminate layer and aligned with the modification in the laminate layer.

Another aspect of the invention relates to a method of generating a multi-layered product using a web lamination machine. The machine includes a position detection device, first and second nip rollers, and a modifying device. The method includes feeding a continuous sheet of a first layer to the first nip roller, the first layer including at least one component positioned thereon, and detecting the position of the component to determine a position of the component relative to the first nip roller. The method also includes feeding a continuous sheet of a second layer to the second nip roller, the first and second nip rollers directing the first and second layers into engagement with each other to form a continuous sheet of multi-layered product. The method still further includes forming an aperture in the second layer based on the determined position of the component such that the component is exposed within the aperture in the multi-layered product.

Another aspect of the invention relates to a method of generating a multi-layered product using a web lamination machine. The machine includes a position detection device, first and second nip rollers, and an altering device. The method includes feeding a continuous sheet of a first layer to the first nip roller, the first layer including a predetermined pattern, and detecting the position of at least a portion of the predetermined pattern with the position detection device to determine a characteristic of the portion of the predetermined pattern. The method also includes feeding a continuous sheet of a second layer to the second nip roller, the first and second nip rollers directing the first and second layers into engagement with each other to form a continuous sheet of multi-layered product, and altering the second layer with the altering device prior to the second layer being fed to the second nip roller based on the determined characteristic of the portion of the predetermined pattern.

Another aspect of the invention relates to a system for generating a multi-layered circuit assembly. The system includes a first roll support configured to support a continuous roll of webbing, the webbing having at least one circuit component positioned thereon, and a second roll support configured to support a continuous roll of laminate layer. The system also includes first and second nip rollers configured to direct the webbing and laminate layers, respectively, into engagement with each other to form a continuous sheet of multi-layered product. A position detection device of the system is positioned between the first roll support and the first nip roller. The position detection device is arranged and configured to monitor a position of at least one circuit component relative to the first nip roller. A modifying device of the machine is positioned between the second roll support and the second nip roller. The modifying device is arranged and configured to modify the laminate layer based on the monitored position of the circuit component.

### BRIEF DESCRIPTION OF THE DRAWINGS

FIG. 1 is schematic representation of one example system for forming a multi-layered circuit according to principles of the invention.

FIG. 2 is a top view of a portion of a continuous multi-layered circuit assembly formed according to principles of the present invention.

FIG. 3 is close up view of two tail portions of the circuit assembly shown in FIG. 2.

FIG. 4 is a flow diagram illustrating an example method of manufacturing a multi-layered circuit according to principles of the present invention.

FIG. 5 is a flow diagram illustrating an example method of generating a multi-layered product according to principles of the present invention.

FIG. 6 is a flow diagram illustrating another example method of generating a multi-layered product according to principles of the present invention.

### DETAILED DESCRIPTION OF THE PREFERRED EMBODIMENT

The present invention provides novel methods and apparatuses for enabling multi-layered circuits to be formed on webs such that electrical connection to the various layers of the multi-layered circuit can be exposed for subsequent connection to each other or external circuitry. In one of its aspects, the invention provides a machine vision registered cutting during the lamination process to expose key areas of the circuit that would otherwise be covered by the laminate layer.

The present invention also provides an efficient solution to the problem of precession when attempting to create multi-layered circuits in web form. In the case where two circuit layers are formed on two separate webs, each in a succession of images, image precession will occur when the two webs are laminated together in register. This happens due to the fact that the pitch between images cannot be exactly maintained, and any small error, when accumulated through many images, will cause the register to shift. There are methods to solve this problem, such as stretching of one web before laminating the images, or cutting the images of one web after each image is laminated, although these, are typically slow and costly processes. Moreover, many web materials cannot be stretched in any effective manner. The present invention allows for a circuit layer to be formed; for a laminate to be adhered to this circuit, with the further ability to expose portions of that first circuit; and for second and other subsequent circuits to be formed in register to each image of the first image. These circuits may be formed by screen printing, photolithography or other imaging techniques.

The methods and apparatuses of the present invention provide for the formation of multi-layered circuits to be formed on continuous webbing members with more efficient utilization of web area. For example, components of the circuit can be positioned such that a connection point of a component can be in the middle area of the web rather than near the edge of the web and still be exposed. This advantage of the present invention is especially useful when dealing with small components. When using small components for construction of a multi-layered circuit and only the edges of the webbing member are available to expose the circuit components, only a row of components can be positioned along each side edge of the web so that the connection point of the components are exposed along the web side edges. The present invention permits positioning of multiple rows on the web that are aligned in any desired orientation relative to a side edge of the web.

A further advantage of the invention is reduced cost of manufacturing, in particular those costs associated with handling the layered products used for assembly of the multi-layered circuit. This advantage may be achieved by using software and machine vision to align the cutting pattern with components of the circuit. In one example, a standard laminate width can be used regardless of the component configuration being run, and only a specified software file is needed in conjunction with that component configuration to run the system/machine. Further, setup times can be greatly reduced as compared to a system in which numerous rolls of pre-slit laminate layers must be aligned with component layouts wherein the slits have a defined width and lane arrangement to correspond to the pattern of components on the webbing to which the laminate layer is secured.

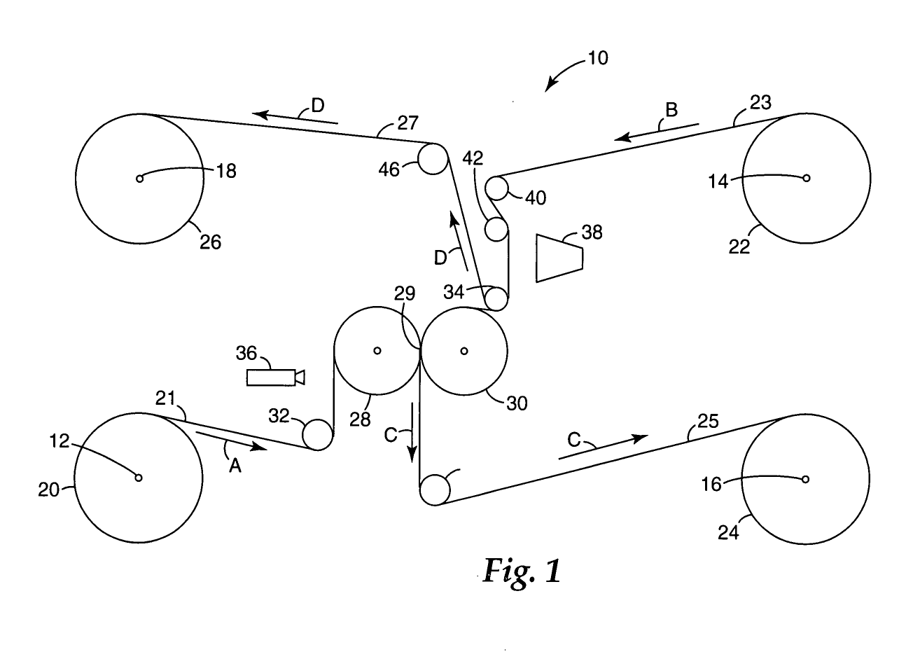

Referring now to FIG. 1, an example schematic system for generating a multi-layered circuit is shown. The system 10 includes first, second, third and fourth roll supports 12, 14, 16, 18 that are configured to support the following respective continuous rolls of material: a first roll 20 of continuous layer 21, a second roll 22 of continuous layer 23, a roll 24 of continuous multi-layer circuit 25, and a continuous roll 26 of release liner 27. The supports 12, 14, 16, 18 may have any desired structure that would permit or provide the rolling up or unrolling of the continuous roll that it supports. The direction arrows A, B, C, D illustrate the direction of motion of each of the layers as they pass through the system 10.

The system 10 also includes first and second nip rollers 28, 30, first and second encoders 32, 34, a position detection device 36, a modifying device 38, and rollers 40, 42, 44, 46. The first encoder 32 and position detection device 36 are positioned between the first roll 20 and the first nip roller 28. The second encoder 34, modifying device 38 and rollers 40, 42 are positioned between the second roll 22 and the second nip roller 30. The third roller 44 is positioned between the first and second nip rollers 28, 30 and the roll 24. The roller 46 is positioned between the encoder 34 and the roll of release liner 26.

In one example, the first roll of continuous layer 21 includes a pattern thereon that is monitored by the position detection device 36 as the continuous layer 21 moves in the direction A toward the fist nip roller 28 and the nip or engagement point 29 between the first and second nip rollers 28, 30. This pattern may be defined in many different ways. In one example, the pattern may be defined by conductive traces, while in another example the pattern is defined by an arrangement of circuit components that includes at least one component mounted on a surface of the layer 21. The pattern is arranged and configured for detection by the position detection device 36.

Preferably, the position detection device 36 maintains a fixed position or travels along a known path whereby it is possible to determine the distance between the point at which the pattern is detected and the nipping point at which the first and second continuous layers 21, 23 contact each other between the first and second nip rollers 28, 30. The position detection device 36 may be, for example, any machine vision device such as a digital video camera, or a simple light sensor used with a mark or hole in the web for each image.

The encoders 32, 34 may be used to track the absolute distance traveled by the web in question so that the precise location of the pattern being detected can be predicted when it arrives at the nip. This certainty enables the precise-location of the modification to the laminate layer (discussed further below), resulting in tight registrations between the component and the modification. Thus, the position detection device 36 and encoders 32, 34 can be used to determine a precise distance between where the pattern is positioned relative to the first layer 21 and the nip point 29.

The modifying device 38 may be positioned at any location along the length of the second layer 23 between the second roll 22 and the second nip roller 30. In the embodiment shown in FIG. 1, the modifying device 38 is positioned between the encoder 34 and the roller 42, but may be positioned at any prior point at which the release liner 27 is separated from the second layer 23. The modifying device 38 may also maintain a fixed position or at least a position along a path in which the distance between the modifying device 38 and the nip point 29 is known at all times. With the distance between the modifying device 38 and the nip point 29 known, and the distance between the feature on the first layer 21 and the nip point known, the second layer 23 can be modified at a location that will provide alignment between the modification and the feature on the first layer 21 when the first and second layers 21, 23 come into engagement with each other at the nip point 29. This type of real-time monitoring of one incoming layer and using the information gathered during the monitoring to modify a second incoming layer just prior to those layers coming into engagement with each other to form a multi-layered product is an advance in the art.

The modifying device 38 can be any type of device capable of modifying or altering a feature of the second layer 23 using such techniques as, for example, cutting, forming, repositioning, shaping, depositing upon, or any other desired means of modifying the second layer in some way. The terms “cut” and“cutting” may be used interchangeably with the terms “modify” and “modifying” throughout this document, but such use is not intended to limit the scope of the terms “modify” or “modifying” to a single definition.

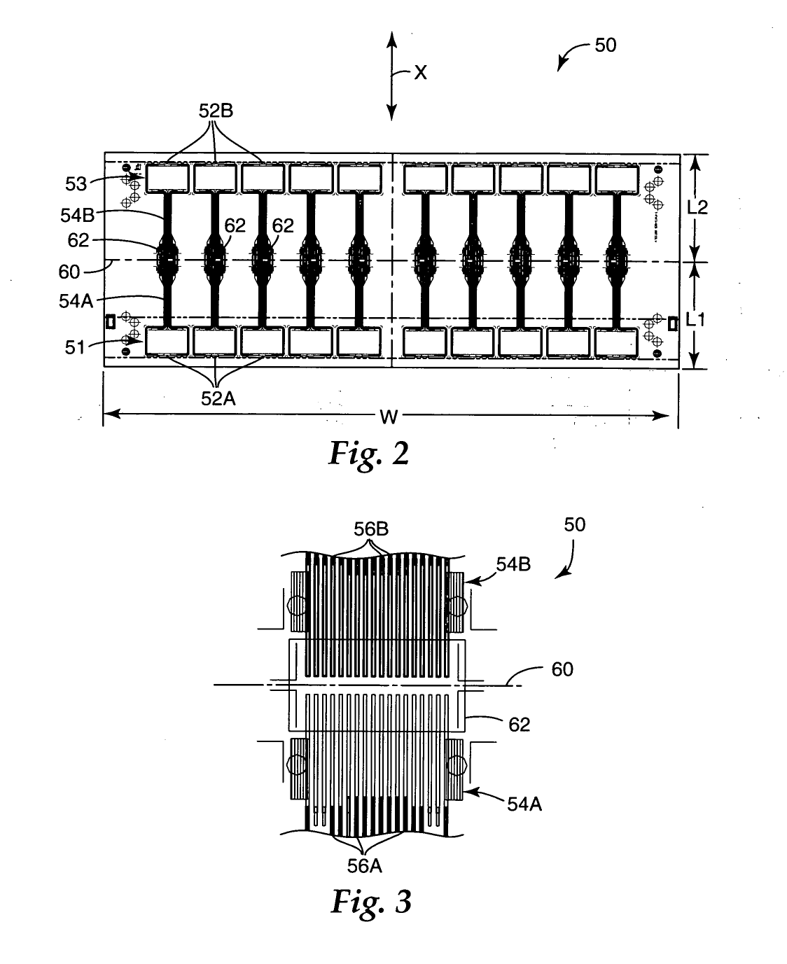

Referring now to FIGS. 2 and 3, a close-up view of a portion of a continuous layer 50 is shown having mounted thereto a plurality of circuit components that are aligned in first and second rows 51, 53, the circuit components being designated 52A within the first row 51 and 52B within the second row 53. The rows 51, 53 are spaced apart in the direction X, which direction designates a direction along the length of the continuous layer 50. A separation line 60 separates the rows 51, 53. Each of the components 52A and 52B includes a tail 54A and 54B, respectively, and a plurality of traces 56A and 56B, respectively, as shown in FIG. 3. Multiple components 52A and 52B extend across the width W of the continuous layer 50. Each of the rows 51, 53 require a respective length L1, L2 of the layer 50.

In the embodiment shown in FIGS. 2 and 3, it is desirable to have ends of the tails 54A and/or 54B exposed for connection. A second continuous layer, or laminate, (not shown) overlaying the circuitry can include one or more cutouts 62 sized to provide exposure of the end portions of the tails 54A and 54B. Cutouts 62 are shown centered about the separation line 60 for each pair of components 52A, 52B. Each cutout 62 defines the desired position of an aperture formed through the laminate that is positioned over the components 52A, 52B. Such apertures 62 can be formed according to principles of the present invention such as the modifying functions of the system 10 described above. In one example process, the apertures 62 are formed with a modifying device, wherein the location of the aperture 62 is based on a monitored position of the circuit components 52A, 52B that has been determined by a position detection device viewing the components on the continuous layer 50. Both monitoring of the components 52A and 52B and forming the aperture 62 occurs prior to engaging the continuous layer 50 with the second layer into which the apertures 62 have been formed. In this manner, the apertures 62 can be precisely aligned with the portions of the tails 54A, 54B that are desired for exposure for future connection.

In one embodiment, the aperture 62 has a size of about 2.5 cm by 2.5 cm (1 square inch), but can have larger or smaller dimensions in different applications. Larger aperture sizes may result in a layer that is weakened to the extent that the layer becomes deformable under stresses resulting from the layer being passed through the system to the nip point. The smaller the size of aperture 62, the greater the requirement for accuracy and precision in forming the aperture at a location that will properly align with the feature (e.g., component or pattern) on the opposing layer. In one example, apertures having a size in the range of 1 to 5 mm on a side are within the capabilities of the invention.

When using the example systems and process described above, it is possible to provide access to the ends of the tails 54A, 54B at any position across the width and along the length of the continuous web 50. In contrast, many known processes require alignment of the component such that the portion of the component desired for exposure must be aligned along a side edge of the continuous layer. If such a requirement were imposed upon the embodiment shown in FIG. 2, only about 3 to 4 components could be aligned along each side edge within the length L1+L2 for a total of about 6 to 8 total circuit components possible mounted on the web 50 within the length L1+L2. This total number of circuit components for a given area ((L1+L2)×W) is significantly less than the 20 circuit components 52A, 52B that can be mounted to the continuous layer 50 according to the example shown in FIG. 2.

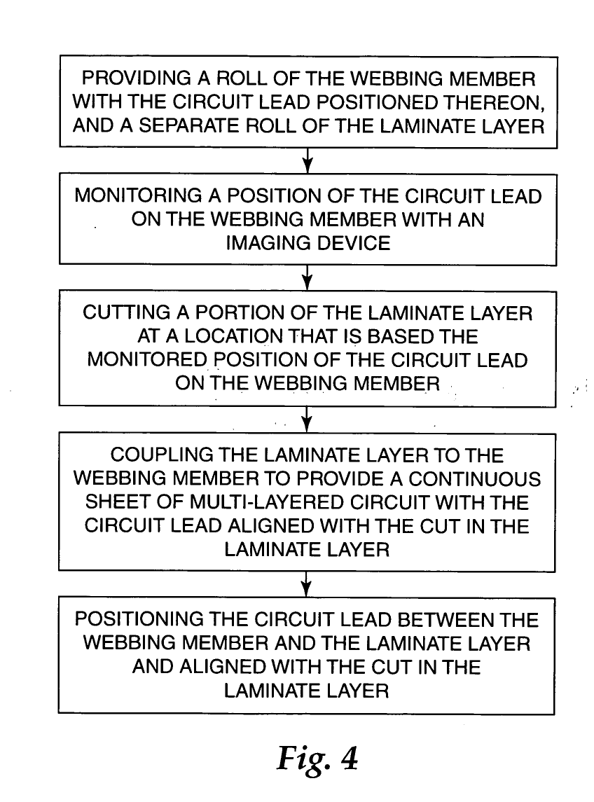

FIG. 4 illustrates steps involved in an example method of the present invention for the manufacture of a continuous multi-layer product. The multi-layer product resulting from the methods described in FIGS. 4-6 can be a circuit or other product that is later cut or diced into separate members along the length and across the width of the continuous multi-layer product. In some embodiments, the resulting separate multi-layer product is a touch-based product such as a touch screen or touch pad. Such a touch screen or touch pad may be used, for example, over a display to control the functions of small electrical devices such as a telephone, personal digital assistant, digital camera or portable media player. Larger sizes may be used as input devices for gaming, kiosk or point of sale terminals. Additionally, they may be used as input digitizers for tablet computers. (See, for example, U.S. Publication 2003/0197688 and U.S. Pat. No. 6,587,097, each incorporated herein by reference.)

The first steps of the method shown in FIG. 4 involve providing a roll of webbing member with a component positioned thereon and providing a separate roll of a laminate layer. The component is merely exemplary of any component or feature of the resultant multi-layered product that is to be exposed for later connection. The component can be positioned at any location along the length and across the width of the webbing member. Preferably, there are no limitations as to the position of the component on the webbing member or the location at which a portion of the component that must be exposed for later connection must be positioned. The rolls of webbing member and laminate layer are spaced apart from each other so that the webbing member and laminate layer can be accessed prior to the two layers engaging each other to form the multi-layer product.

If the resultant multi-layer product is to be transparent, the web should be a transparent or at least translucent plastic film. Any plastic film suitable for membrane switches and touch panels can be used for the webbing member and laminate layer, with a polyester film such as Mylar® sold by Dupont being preferred. Other films including nylons, polycarbonates, polyethylene;naphalate, polyethersulphone; vinyl, polyimide, polypropylene, paper, etc., can be used. The webbing member and laminate layer can be a thin film having a thickness on the order of, for example, about 1 mils to about 10 mils thick. Thicker film layers may be used for the webbing member to provide additional support for mounting of the component. One advantage of the present invention is that it can be used with relatively thin webbing and laminate layers to produce a relatively thin multi-layer product.

The webbing member and laminate layer can each be a single layer of film, such as plastic film, or may each be a multi-layer film. The laminate layer may include a separate release liner that is applied over an exposed surface of adhesive on one side of the laminate layer. The liner can be stripped away from the laminate layer prior to the webbing member and laminate layer coming into engagement with each other, thereby providing a means of securing the webbing member and laminate layer together with the component positioned therebetween.

The webbing member and laminate layer are typically provided as a roll of plastic film. Such rolls of film are typically several hundred feet long to several thousand feet long, making it possible to form a continuous multi-layer product having a desired length. Initially, the webbing member must have a length long enough to accommodate at least one component. It is also envisioned that the webbing member may be long enough to include a plurality of rows and columns of components positioned along the length of the webbing member.

The next step of the method shown in FIG. 4 includes monitoring a position of the component on the webbing member with an imaging device. The system includes a monitoring device such as a camera or video device that monitors the webbing member as it moves from the roll of webbing member toward the nip or engagement point. A distance between the point at which the monitoring device is monitoring the webbing member and the engagement point between the webbing member and laminate layer must be known in order to properly perform the other steps of the method described below. In some embodiments, encoders may be used to provide this distance determination. Information provided by the monitoring device can be used to determine a position of the component relative to the webbing member itself and relative to the engagement point. An example monitoring device that may be, used in this and other example processes disclosed herein is a Machine Vision System such as DVT 700 series or Cognex Checkpoint 800 series. Other more simple monitoring devices may include, for example, a light sensor that monitors a mark or hole in the web for each image. Alternatively, a plurality of monitoring devices can be used along the length and across the width of the webbing member. Preferably, monitoring of the position of the component is performed while the webbing member is moving towards the engagement point.

The next step of the method shown in FIG. 4 includes modifying a portion of the laminate layer at a location that is based on the monitored position of the component on the webbing member. The modifying function may be performed by a modifying device such as a laser cutting device. Example laser cutting devices include a CO₂ laser, an indexable rotary die cutter, and other computer numerical control knife cutting systems. Preferably, the cutting device can cut with a level of precision that permits cutting through the laminate layer to the liner (known as a “kiss cut”) such that the liner maintains its integrity. Such a cut that does not pierce the liner makes it possible for the liner to remove that waste cut portion of the laminate layer at the time when the liner is removed. One advantage of this configuration is that the waste cut portion of the laminate layer does not need to be removed in a separate step. A further advantage is that the laminate layer does not need to be cleaned after removal of the waste cut portion prior to engagement of the laminate layer with the webbing member.

The use of precision cutting devices such as a galvo-based beam delivery system makes it possible to cut the laminate layer while the laminate layer is moving at a relatively high speed. In one example, the laminate layer is moving at a speed of at least 10 feet per minute, and more preferably at a speed of about 20 to 50 feet per minute. Rotary Die Cutting could be used for much faster speeds, on the order of hundreds of feet per minute but would require hard tooling for every part number and significant time for changeovers and setups. Intermittent motion flat die cutting may cause web control and tension problems as well as potentially leaving witness marks on the assembly at locations where the web is stopped inside the nip, unless an accumulator system was added to the machine to allow continuous movement of the laminating rollers while part of the web was stationary for flat die cutting. Speeds even greater than 50 feet per minute are possible depending on the power and speed of the cutting system and the complexity of the patterns to be cut. Alternatively, the web can be stopped for die-cutting and then re-started.

The location on the laminate layer at which the cutting device conducts cutting is determined in part based on information provided by the monitoring device. As with the position of the monitoring device, the position of the cutting device relative to the engagement point between the webbing member and laminate layer must be known at all times. With these distances known, it is possible to cut the laminate layer at a location that corresponds to that portion of the component that is to be exposed in the continuous multi-layer product. This process of real-time monitoring of a position of the component and performing a real-time cutting function based on the monitored position provides certain advantages. One such advantage is that a high degree of precision can be provided for the location of the cut so that the cut aligns properly with a portion of the component that is desired for exposure. Another advantage is the elimination of handling and positioning of the laminate layer relative to the webbing member after cutting is performed. A still further advantage is that each individual component is individually registered with a cut in the laminate layer, making it possible to account for minor errors in positioning of the component on the webbing member or setting up the system for various patterns and arrangements of components on the webbing member. It is desirable that in the case in which sequential images have been formed on the first web, that the cutting device is cutting a pattern that will join with the specific image that the position detection device is monitoring. This will ensure that any small variations in pitch from image to image will not affect registration.

The next step of the method shown in FIG. 4 includes coupling the laminate layer to the webbing member to provide a continuous sheet of multi-layered product with the component aligned with a cut in the laminate layer. The coupling function can be performed in many different ways including, for example, engaging the webbing member and laminate layer together with nip rollers. Nip rolling processes are well known in the art and are especially useful when handling continuous rolls of layers or liners. Nip rolling also provides a constant nip or engagement point where the two layers first come into contact with each other. This known engagement point is especially useful for the present invention as it provides a reference point for both the monitoring and cutting functions described above. When there is proper setup and coordination of the cutting function based on the monitored position of the component, the cut in the laminate layer should adequately align with that portion of the component that is desired for exposure through the laminate layer. Concurrent with the coupling step described above is another step of positioning the component between the webbing member and the laminate layer and aligned with the cut in the laminate layer. This final step may be the result of completing the other steps of the method described above.

Further steps of the method of FIG. 4 (not shown) may include essentially repeating the steps of the method to add additional components and additional layers to the continuous multi-layer product. Such steps may include first adding one or more components to an exposed surface of the multi-layered product (e.g., on the remaining exposed surface of the webbing member or laminate layer). The multi-layer product with the newly added components can then be used in place of the webbing member in the steps described above with reference to FIG. 4. As a result, a position of the newly added component is monitored with an imaging device, a portion of the second laminate layer is modified at a location based on the monitored position of the new component on the multi-layer product, and the laminate layer is coupled to the multi-layer product to provide a second layer to the multi-layer product with the new component aligned with the cut in the second laminate layer. In some embodiments, the second laminate layer may be additionally modified so as to provide exposure of the first component in addition to exposure of the second component. These process steps can be repeated numerous times to provide any desired number of layers of components and laminate layers to produce a continuous multi-layer product.

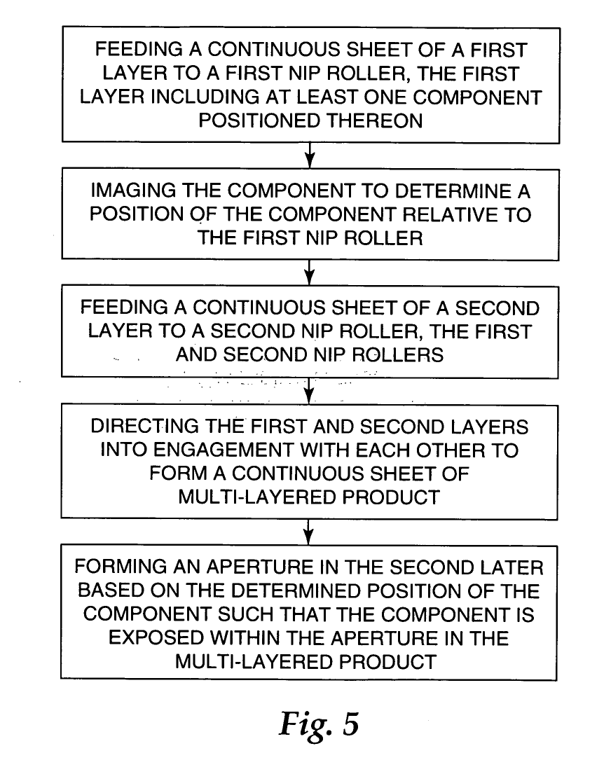

Referring now to FIG. 5, another method according to principles of the present invention is described. The method of FIG. 5 includes first feeding a continuous sheet of a first layer to a first nip roller, wherein the first layer includes at least one component positioned thereon. This feeding step may include unrolling a continuous sheet of first layer from a roll of the first layer and passing the continuous sheet of first layer to a first nip roller. The first layer includes a component such as a semiconductor chip, conductive trace, touch sensitive device, or any other desired component mounted thereto.

Another step of the method of FIG. 5 includes detecting the position of the component to determine a position of the component relative to the first nip roller. Detection of the component may be performed using a position detection device such as a machine imaging device or a light sensor. The position detection device can be used to determine a position of the component relative to a feature of the nip roller or to a feature of the first layer, such as, for example, a side edge, centerline, or reference point along the length of the first layer. The first nip roller provides a constant reference point for determining a position of the imaging device and a component mounted to the first layer.

The method of FIG. 5 also includes feeding a continuous sheet of a second layer to a second nip roller. The first and second nip rollers are configured to direct the first and second layers into engagement with each other to form a continuous sheet of multi-layered product. The point of engagement between two layers that are fed into engagement with each other using nip rollers is an engagement or nip point.

The next step in the method of FIG. 5 includes forming an aperture in the second layer based on the determined position of the component on the first layer such that the component is exposed within the aperture. This step preferably occurs before the above-described feeding step to improve the ease of modifying the second layer. In one example method, the modifying step includes cutting the second layer to produce a waste cut portion of the second layer. Different means and methods can be used to remove the waste cut portion. In one example, a release liner of the second layer can carry the waste cut portion away from the second layer prior to the second layer coming into engagement with the first layer.

In the methods described in FIGS. 4-6, additional positional information related to the component mounted on the first layer and the modification in the second layer can be obtained using such devices as encoders positioned relative to each of the layers coming to engagement with each other. Encoders are particularly useful for tracking the absolute distance traveled by the web in question so that the precise location of the pattern being detected can be predicted when it arrives at the nip. This certainty enables the precise location of the feature to be cut, enabling tight registration. Without an encoder or similar device, slight speed variation in a drive and minor tension fluctuations could cause the tracked pattern on the web to be in a different position from where you expect it to be.

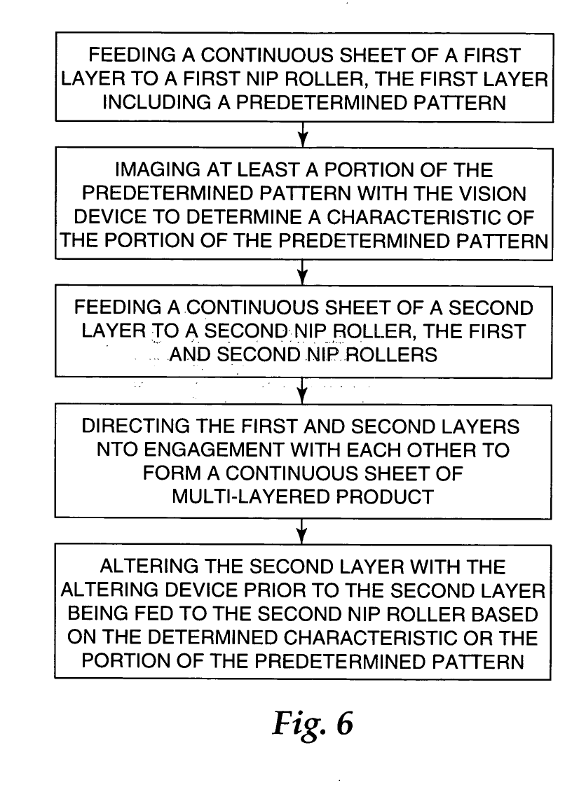

Referring now to FIG. 6, another method is described as a variation of the method described with reference to FIG. 5. The method of FIG. 6 includes feeding a continuous sheet of first layer to the first nip roller wherein the first layer includes a predetermined pattern. The predetermined pattern may be defined in different ways including, for example, the position of a component relative to other features of the first layer (e.g., a side edge or a position along the length of the first layer). The pattern may also include a plurality of components arranged in any desired pattern. The predetermined pattern may also be defined by, for example, circuit traces for electrical connection of components mounted to the first layer, or deposits such as ink deposits that provide, for example, shading, borders, or aesthetic designs.

Another step of the method of FIG. 6 includes detecting at least a portion of the predetermined pattern with a position detection device to determine a characteristic of the portion of the predetermined pattern. The detecting may be performed using, for example, real-time video imaging, light sensor detection, laser, or other types of imaging that may be performed preferably while the first layer is moving towards the first nip roller. The characteristic of the predetermined pattern may include, for example, a location determination of a portion of the predetermined pattern relative to, for example, a first nip roller or other features of the first layer. Another characteristic may be a defect in the predetermined pattern or the beginning or end of the pattern. In the case of repeating sequential images on the web, a reference mark or hole that is positioned in register to each image may be detected by the light sensor or a laser. This position information can then be used to determine the position of the image with respect to the nip or other reference point. The mark or hole may be a registration mark used in forming the image or pattern on the first layer.

The method of FIG. 6 also includes feeding a continuous sheet of a second layer to a second nip roller wherein the first and second nip rollers direct the first and second layers into engagement with each other to form a continuous sheet of multi-layered product. The point of engagement of the first and second layers typically defines a nip or engagement point that can be used as a reference in the altering step (described below).

Another step in the method of FIG. 6 includes altering the second layer with the altering device prior to the second layer being fed to the second nip roller, wherein the altering is based on the determined characteristic of the portion of the predetermined pattern. Altering of the second layer may include, for example, cutting, repositioning, shaping, depositing upon, or any other desired means of altering the second layer in some way. The altering occurs based upon the determined characteristic of the portion of the predetermined pattern. In one example, altering of the second layer includes cutting the second layer and the determined characteristic is a position of a component on the first layer. In this example, the cut in the second layer corresponds with the position of a component in the first layer so that the component and cut align with each other when the first and second layers are brought into engagement with each other.

There have thus been described several new processes for the manufacture of a continuous multi-layer product in which one layer of the multi-layer product is altered in some way based upon a monitored aspect of another layer of the multi-layer product. One aspect of the new processes relates to the real-time monitoring and altering steps, which provides certain advantages described above with reference to the several Figures. The processes and system provide an efficient method for manufacturing a continuous multi-layer product, and are especially useful for production of a multi-layer product that incorporates multiple thin film layers.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of manufacturing a multi-layered circuit assembly, the assembly including a webbing member, a component, and a laminate layer, the method comprising the steps of:
providing a roll of the webbing member with the component positioned thereon, and providing a separate roll of the laminate layer;
monitoring a position of the component on the webbing member with a position detection device while the component is not in contact with the laminate layer;
modifying a portion of the laminate layer at a location that is based on the monitored position of the component on the webbing member while the laminate layer is not in contact with the component; and
coupling the laminate layer to the webbing member to provide a continuous sheet of multi-layered circuit, wherein the component is positioned between the webbing member and the laminate layer and aligned with the modified portion of the laminate layer.

2. The method of claim 1, further comprising removing the modified portion of the laminate layer to expose the component through the laminate layer.

3. The method of claim 1, wherein the position detection device is an optical detection system.

4. The method of claim 3, wherein the position detection device is a machine vision camera.

5. The method of claim 2, wherein the laminate layer includes a release liner and removing the release liner after the modifying step removes the modified portion of the laminate layer.

6. The method of claim 1, wherein the coupling step includes passing the modified laminate layer and the webbing member between nip rollers.

7. The method of claim 1, wherein the monitoring and modifying steps occur while the respective webbing member and laminate layer are moving towards each other in preparation for the coupling step.

8. The method of claim 1, wherein the webbing member includes a plurality of components mounted thereon, the monitoring step includes monitoring a position of at least one of the components on the webbing member with the position detection device, and the modifying step includes modifying a portion of the laminate layer at a plurality of locations, the location of each modification being based on the monitored position of one of the plurality of components on the webbing member.

9. The method of claim 8, wherein coupling the laminate layer to the webbing member results in each of the plurality of components being positioned between the webbing member and the laminate layer and aligned with a modification in the laminate layer.

10. The method of claim 1, further comprising:
mounting another component to an exposed surface of the continuous sheet of multi-layered circuit;
providing a separate roll of another laminate layer;
monitoring a position of the another component on the continuous sheet of multi-layered circuit with the position detection device;
modifying a portion of the another laminate layer at a location that is based on the monitored position of the another component on the continuous sheet of multi-layered circuit; and
coupling the another laminate layer to the exposed surface of the continuous sheet of multi-layered circuit, wherein the another component is positioned between the exposed surface of the continuous sheet of multi-layered circuit and the another laminate layer and aligned with the modification in the another laminate layer.

11. The method of claim 10, wherein the steps of monitoring the another component and modifying the another laminate layer occur while the respective continuous sheet of multi-layered circuit and another laminate layer are moving towards each other in preparation for coupling the another laminate layer to the continuous sheet of multi-layered circuit.

12. A method of generating a multi-layered product using a web lamination machine, the machine including a position detection device, first and second nip rollers, and a modifying device, the method comprising:
feeding a continuous sheet of a first layer to the first nip roller, the first layer including at least one component positioned thereon;
detecting the position of the component to determine a position of the component relative to the first nip roller;
feeding a continuous sheet of a second layer to the second nip roller, the first and second nip rollers directing the first and second layers into engagement with each other to form a continuous sheet of multi-layered product; and
forming an aperture in the second layer based on the determined position of the component such that the component is exposed within the aperture in the multi-layered product.

13. The method of claim 12, wherein the aperture is formed using a laser.

14. The method of claim 12, wherein the position of the component is detected by an optical detection system.

15. The method of claim 14, wherein the component position is detected using a video camera.

16. The method of claim 12, wherein the second layer includes a release liner, and the method further includes removing the release liner prior to directing the first and second layers into engagement with each other.

17. The method of claim 16, wherein removing the release liner removes a waste portion of the second layer resulting from forming the aperture.

18. The method of claim 12, wherein the detecting and forming steps occur while the respective first and second layers are moving towards the respective first and second nip rollers.

19. A method of generating a multi-layered product using a web lamination machine, the machine including a position detection device, first and second nip rollers, and an altering device, the method comprising:
feeding a continuous sheet of a first layer to the first nip roller, the first layer including a predetermined pattern;
detecting the position of at least a portion of the predetermined pattern with the position detection device to determine a characteristic of the portion of the predetermined pattern;
feeding a continuous sheet of a second layer to the second nip roller, the first and second nip rollers directing the first and second layers into engagement with each other to form a continuous sheet of multi-layered product; and
altering the second layer with the altering device prior to the second layer being fed to the second nip roller based on the determined characteristic of the portion of the predetermined pattern.

20. The method of claim 19, wherein the position is detected using an optical sensor.

21. The method of claim 19, wherein the position is detected using a machine vision video camera.

22. The method of claim 19, wherein the predetermined pattern is defined by at least one circuit component mounted to the first layer.

23. The method of claim 19, wherein the characteristic of the predetermined pattern is a position of a portion of the pattern relative to the first nip roller.

24. The method of claim 19, wherein the characteristic is determined as the first layer is being fed to the first nip roller.

25. The method of claim 19, wherein the altering device is a cutting device, and altering the second layer includes cutting a portion of the second layer.

26. The method of claim 19, wherein altering the second layer includes altering at least one of the structure of the second layer and a position of the second layer relative to the first layer.

27. The method of claim 19, wherein altering the second layer includes removing a portion of the second layer to form an aperture such that the portion of the predetermined pattern is exposed within the aperture in the multi-layered product.

28. A system for generating a multi-layered circuit assembly, the system comprising:
a first roll support configured to support a continuous roll of webbing, the webbing having at least one circuit component positioned thereon;
a second roll support configured to support a continuous roll of laminate layer;
first and second nip rollers configured to direct the webbing and laminate layers, respectively, into engagement with each other to form a continuous sheet of multi-layered product
a position detection device positioned between the first roll support and the first nip roller, the position detection device being arranged and configured to monitor a position of the at least one circuit component relative to the first nip roller; and
a modifying device positioned between the second roll support and the second nip roller, the modifying device being arranged and configured to modify the laminate layer based on the monitored position of the circuit component.
